(19) United States
(12) Patent Application Publication
(10) Pub. No.: US 2008/0263164 A1
(43) Pub. Date: Oct. 23, 2008

(54) Method of Sending Motion Control Content in a Message, Message Transmitting Device Abnd Message Rendering Device

(75) Inventors: Thomas Portele, Bonn (DE); Peter Joseph Leonardus Antonius Swillens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,904

(22) PCT Filed: Dec. 13, 2006
(86) PCT No.: PCT/IB2006/054811

§ 371 Date: Jun. 18, 2008

(30) Foreign Application Priority Data
Dec. 20, 2005 (EP) 05112499.8

(51) Int. Cl. G06F 15/16; G06F 19/00

(52) U.S. Cl. 709/206; 700/245; 901/14; 901/50

(57) ABSTRACT

The invention describes a method of sending a message (M) from a sender to a recipient in which a record content (S₁, S₂, S₃, S₄, S₅, S₆, S₇) of the message (M) is recorded and supplemented with motion control content (T₁, T₂, T₃, T₄, T₅, T₆, T₇). The message (M) is transmitted from a transmitting device (10) of the sender to a message rendering device (40) of the recipient, which message rendering device (40) is capable of performing motion. The message rendering device (40) is controlled according to the motion control content (T₁, T₂, T₃, T₄, T₅, T₆, T₇) to perform defined motion synchronised to a presentation of the record content (S₁, S₂, S₃, S₄, S₅, S₆, S₇) of the message (M). Furthermore, an appropriate message transmitting device (10), an appropriate message rendering device (40) and an message transmission system (1) are described.

The invention relates to a method of sending a message from a sender to a recipient.

Moreover, the invention relates to a message rendering device capable of performing motion and to a message transmitting device for transmitting a message to such a message rendering device. Furthermore, the invention relates to a message transmission system, comprising such a message transmitting device and such a message rendering device.

Since the development of online user-groups and chat-rooms a few decades ago, messaging systems, which allow users to communicate by exchanging messages, have been enjoying a continual growth in user acceptance, particularly with the rapid expansion of the world wide web and the internet. Other messaging systems allow users to send messages by means of, for instance, telephones or mobile telephones.

The early messaging scenario, involving a user typing in his message by means of a keyboard, and the message subsequently appearing in written form on the destination user's PC, is quickly becoming out-dated as messaging systems use the increased bandwidth available to send video as well as audio message content. Today, messages with incorporated items are in widespread use, e.g. emails in HTML format with included images, emails containing audio data or movies, MMS messages etc. These additional features are closely coupled to the medium used for conveying the message to the user, i.e. embedded sound in phone messages, images in emails shown on a computer screen etc. In the past, it has been common that nearly all possibilities of a messaging medium have been used to enhance the experience when receiving a message. An example is an avatar on the screen moving according to the content of the message, which is described in WO 2004/0795390 A1. In this concept the avatar may perform an animation selected from a number of predefined animations depending on the message.

It is an object of the invention to provide a method of sending a message as well as a message transmitting device, a message rendering device and a message transmission system, to further enhance the experience for the recipient when receiving a message.

To this end, the present invention provides a method of sending a message from a sender to a recipient in which a record content of the message is recorded and supplemented with motion control content, where the message is transmitted from a transmitting device of the sender to a message rendering device of the recipient, which message rendering device is capable of performing motion and where the message rendering device is controlled—while presenting the message to the recipient—according to the motion control content to perform defined motion synchronised to a presentation of the record content of the pertinent message.

The “record content” of the message can basically be any further content not pertinent to the motion of the message rendering device, such as a message in text form for showing on a display on the message rendering device or for converting to an audible speech output. The record content can also comprise recorded audio or video data, recorded in any suitable manner using, for example, with a microphone, webcam, or similar. A “recording” can also mean that a message is generated partially automatically by the sender by means of control commands (for example an out-of-office message), or entirely automatically.

The term “motion” can mean any movement of the entire message rendering device or—in the case of a message rendering device comprising several parts—a “robot part” of this message rendering device, by means of which the device or robot part moves from one location to another. The term “motion” can also mean movement of certain parts of the message rendering device or robot part, i.e. that certain gestures are performed.

Together with the rest of the message content, the synchronised output of movements according to the invention allows the communication of choreographic elements. Thereby, the experience of message reception is greatly enhanced. In this way, for example, an actual embrace or polite gestures such as a bow can be communicated along with the message. This opens up an entirely new dimension in message transfer in which all modes of communication generally used by humans in their interactions are taken into consideration.

An appropriate message transmitting device for transmitting a message—according to the invention—to a message rendering device capable of performing motions, should comprise a message recorder for recording a record content of the message, a motion control content generator for generating motion control content, a motion control content embedding unit for embedding the motion control content into the record content of the message, and a transmitter for transmitting the message to the message rendering device. Thereby, the motion control content generator and the motion control content embedding unit are realized so that the motion control content is generated and embedded in the record content of the message in such a way that the message rendering device, while presenting the message to the recipient, can be controlled according to the motion control content to perform defined motion synchronised to a presentation of the record content of that message.

Furthermore, an appropriate message rendering device should comprise a receiver for receiving a message from a message sending device, an outputting means, e.g. a display, and/or a loudspeaker, for presenting at least part of a record content of the message, and a motion means for performing motions of the body and/or parts of the body of the message rendering device. The term “body” can mean any kind of housing, and the term “body part” can mean any moveable part of the housing of the message rendering device or—in the case of a message rendering device comprising several parts—a “robot part” of this message rendering device. Moreover, a message rendering device according to the invention should comprise a message analysing unit for detecting motion control content in the message and a motion control unit for controlling, while presenting the message to the recipient, the motion means according to the motion control content to perform defined motions synchronised to a presentation of a record content of the pertinent message while presenting the pertinent message.

Systems with the capability for movement are already known. Examples are the AIBO dog robot from Sony, other robots like NEC's ASIMO, or the RoboSapiens. These devices are, or may be, capable of communicating with remote machines over networks. Therefore, they are, on principle, capable of receiving messages for a certain user, and delivering the message. For example, one of the features of the AIBO is the notification of the user if a new e-mail has arrived. With suitable additions, such a device could be relatively easily converted for message communication according to the invention.

The various components of the message transmitting device and the message rendering device, in particular the motion control content generator and the motion control content embedding unit within the message transmitting device, as well as the message analysing unit and the motion control unit of the message rendering device can also be realised in software in the form of programs or algorithms running on suitable processors of the relevant devices.

A message transmission system should comprise at least a corresponding message transmitting device to transmit a message, as well as a message rendering device according to the invention for rendering the message. Usually, however, such a system would comprise many such message transmitting devices und message rendering devices.

A message transmitting device and a message rendering device are preferably realised in the form of an integrated message transmitting/rendering device, i.e. the message rendering device would also comprise a message recorder, a motion control content generator, a motion control content embedding unit and a suitable transmitter, whilst the message transmitting device would comprise a suitable receiver, an outputting means, a motion means, a message analysing unit and a motion control unit. Messages can be sent as well as received, in the manner according to the invention, using such a message transmitting/rendering device.

A message transmission system preferably comprises a plurality of such combined message transmitting/rendering devices, whereby it is not to be ruled out that the system also comprises exclusively message transmitting devices or exclusively message rendering devices.

At this point, it will be emphasised that the message transmitting device and in particular the message rendering device could also be realised by means of spatially separate components. For example, the entire analysis of a received message could first be carried out on a separate device which identifies motion control content and which subsequently furthers the appropriate commands to a robot unit, which in turn carries out the movements accompanying the remaining message content, whereby the remaining message content can also be furthered to the robot for rendering. However, it is also possible that the remaining message content is output on a different device, for example a stereo system with loudspeakers, or a television screen or another display available on the recipient's side, i.e. rendering the movements can be separated from rendering the acoustic message or video or image message content. Nevertheless, in the following, without limiting the invention in any way, it will be assumed that the message transmitting device and the message rendering device are robots or devices similar to robots, comprising all components necessary for realisation of the invention.

The dependent claims and the subsequent description disclose particularly advantageous embodiments and features of the invention. Further developments of the device claims and the system claim corresponding to the dependent method claims also lie within the scope of the invention.

The motion control content can be included essentially in any way in the message, and linked to the record content, so that the movement can be synchronised to the output of the record content. For example, the temporal output of the record content and the motion control content can be relative to a common starting time.

Robot movements are usually controlled by a mixture of autonomous movements (i.e. to keep upright) and externally controlled movements (e.g. moving an arm forward). This control can be received via a remote control, a control computer, or a script running on the robot itself. Some implementations support higher-level control by means of the Internet by, for example, using an XML dialect (RoboML and others). Therefore, in a preferred embodiment, to generate a message according to the invention, the usual type of messaging methods are implemented, and combined with such a high-level robot control in order to be based on established methods and to maintain a consistent standard. Motion control content is therefore preferably embedded in the record content in the form of so-called “tags”, particularly for a text content which can be output either in text form or in the form of acoustic speech output. In other words, a message protocol might be used, in which tags similar to those defined by robot control languages like RoboML are embedded in the message text. Thereby, the tags may optionally be used in combination with other tags addressing additional modalities, for example tags for images, SMIL-like tags for multimedia presentations, Philips PML-tags for external devices in the room, etc.

There are various possibilities for describing the motion control content within the message.

Preferably, the message transmitting device, for example in the case of a combined message transmitting/rendering device, is also capable of performing motion. In this case, the motion control content is described according to the setup and the motion capabilities of the message transmitting device. At some point along the way from message transmitting device to message rendering device, the control content, configured with regard to the message transmitting device, is converted to a description pertaining to the setup and motion capabilities of the motion rendering device.

In such a conversion (in the following also referred to as a “translation”), for example, control commands for movements which could be carried out by the capabilities of the message transmitting device are replaced by control commands which can be carried out instead by the capabilities available to the message rendering device. An example of such a case is when the message transmitting device is a robot that can nod its head, and the message rendering device does not have such a head, but can move an “eyelid” to “wink” at the user. In such a case, a nod of the head, interpreted as confirmation by the message transmitting device, could be converted to the blink of an eye with the same interpretation for the message rendering device.

If certain control commands cannot be realised or converted to another form, these may also be left out, or be replaced by a suitable text or speech output, in order to inform the recipient of the message that the sender had intended that a certain movement by carried out at that point.

This translation of the motion control content may be carried out on the sender's side, based on information pertaining to a setup and/or to motion capabilities of the message rendering device. Therefore, the information pertaining to the setup and/or to motion capabilities of the message rendering device may be stored in a recipient profile memory, preferably a database, of the message rendering device. In other words, all the setups and/or capabilities of the various kinds of message rendering devices to which the user can communicate messages with motion content by means of the message transmitting device are stored and can be accessed in some way by the message transmitting device. It can also suffice that an identification number or a type specification of the message rendering device is known, and further information about setup or motion capabilities of the receiving devices can be obtained or retrieved from other databases, such as from the internet.

Since the interpretation of the meaning of the various movements also plays a role, and this should be known when translating, the translation of the motion control content, in a preferred embodiment, is performed on the recipient side, based on information pertaining to a setup and/or to motion capabilities of the message transmitting device. Here also, the required information can be stored in a memory which can be accessed by the message rendering device, such as a database for several message transmitting devices.

In a further preferred embodiment of the invention, the information pertaining to the setup and/or to the motion capabilities of the message transmitting device are included in the message itself. For example, a “capability description” of the message transmitting device can be embedded or included in the header of the message. The message rendering device first reads this capability description, and uses this for the translation of the motion control content. The capability description can be stored in a memory of the message rendering device for later communications with the transmitting device, as already described above. Also, the rules for translation of specific motion control content, which may be defined based on the information pertaining to a setup and/or to motion capabilities of the message transmitting device on the one side and on information pertaining to a setup and/or to motion capabilities of the message rendering device on the other side, may be stored for later communications with the transmitting device, or transmitting devices of the same type with the same capability description.

To synchronise the movements of the message rendering device with the output of the message itself, the motion control content comprises a temporal starting point for a certain movement relative to the presentation of the message record content, as well as a corresponding duration which specifies how long the movement is to be performed. Alternatively, a start time and end time in the presentation can be defined.

Furthermore, besides the start time, a duration as well as an end time can be defined for a movement, whereby the chosen duration can be defined as either a lower or an upper bound, i.e. a movement can be terminated after reaching an end-time or after a certain duration has elapsed, depending on which event arises first. Equally, a movement may be terminated when both events arise, i.e. the final event determines the effective duration of the movement.

When the motion control content is embedded in the message text in the form of tags, the start time can be defined relatively easily by inserting the start of the relevant tag at the desired position in the message text. Equally, an end-time of a duration can be defined in such a simple manner.

There are various way of generating the motion control content, in particularly the tags. For example, already existing robot control tools can be implemented, as described in, for example, “Survey of robot programming systems” by Biggs & MacDonald. Proceedings Australasian Conference on Robotics and Automation, 2003, Brisbane. In another approach, the message can be generated based on a movement of the message transmitting device. For example, on the sender's side, the movements of a robot, whose body or body parts can be moved manually or by remote control, can be recorded and converted into the desired form such as tags, and embedded in the message content. Synchronisation can be performed by first recording the message record content and then replaying this while at the same time causing the robot to perform the relevant movements at the desired positions in the message.

Other objects and features of the present invention will become apparent from the following detailed descriptions considered in conjunction with the accompanying drawing. It is to be understood, however, that the drawings are designed solely for the purposes of illustration and not as a definition of the limits of the invention.

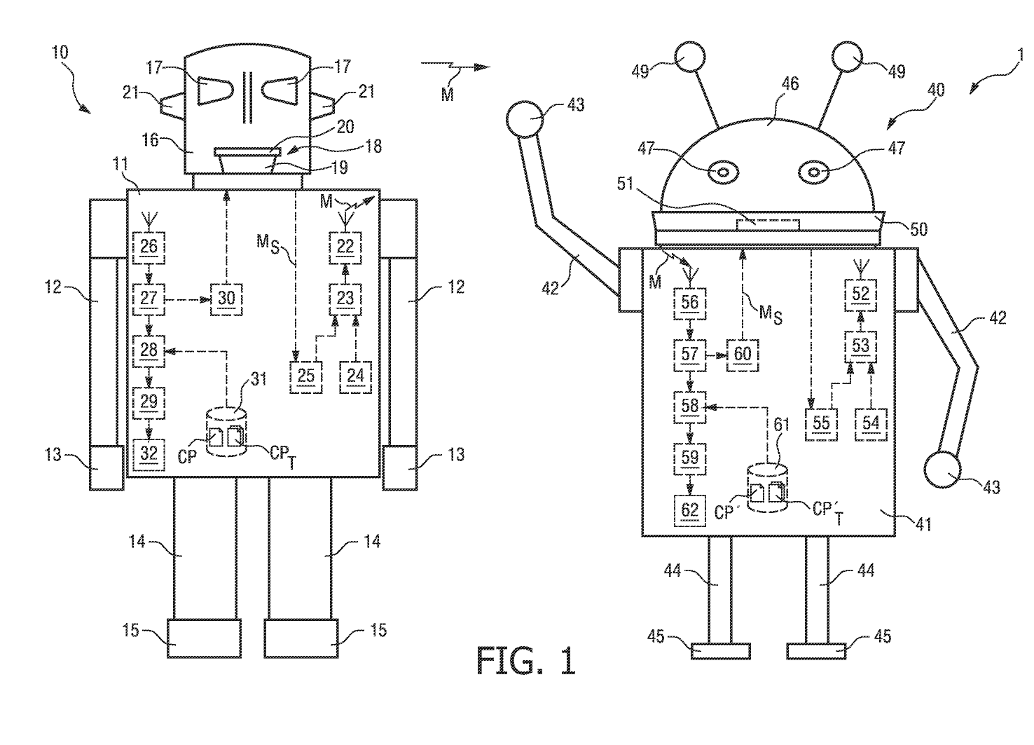

FIG. 1 is a schematic representation of a message transmission system according to an embodiment of the invention comprising two different message transmitting/rendering devices;

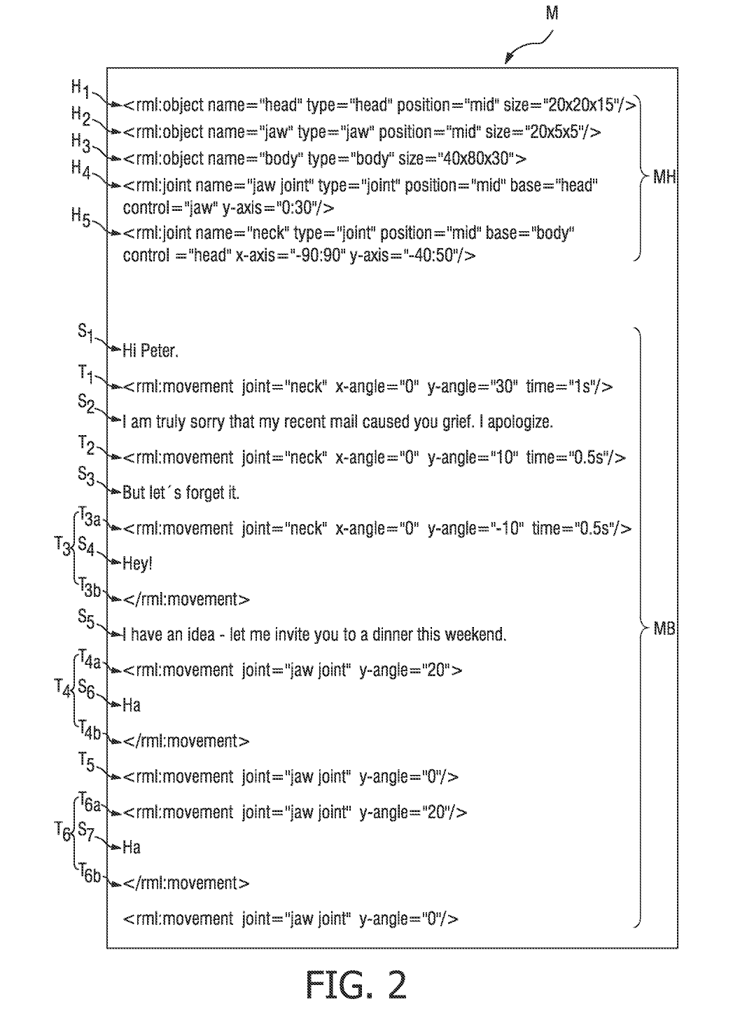

FIG. 2 an example for a message comprising motion control content in form of tags embedded in text record content.

The message transmission system 1 shown in FIG. 1 comprises two message transmitting/rendering devices 10, 40, both realised as robots. In the following, the left-hand message transmitting/rendering device 10 serves as a message transmitting device 10, which transmits a message M to the right-hand message transmitting/rendering device 40, acting as a message rendering device 40. Naturally, their roles could be reversed, since, as will be explained below, both devices 10, 40 comprise the necessary components for both receiving and transmitting messages by the method according to the invention.

The message transmitting device 10 is realised in a robot with a block-shaped trunk 11, with arms 12 attached by joints at the sides, and claws 13 serving as hands attached at the ends of the arms 12. Also, the robot has legs 14 attached to its trunk 11, which in turn are equipped with feet 15. The illustration is a very simplified representation—such a robot can, of course, feature knees, elbows, etc.

A head 16 is attached to the top of the trunk 11. The head 16 has two cameras 17, acting as eyes, and two microphones 21 acting as ears. The robot also has a mouth 18, with a lower jaw 19 which can open downward, allowing basic mouth movements to be performed. Part of the mouth is a loudspeaker 20 by means of which the robot can output speech.

A number of control components are contained inside the robot in order to move the robot, record visual and audible sound, and to output acoustic signals via the loudspeaker 20. There are numerous ways of realising and controlling a robot, and these will be known to a person skilled in the art.

The following components, shown by the dashed lines in FIG. 1, are also incorporated in the trunk 11 of the robot and are used to send a message in the manner of the invention:

Firstly, the robot comprises a message record unit 25. With this message record unit 25, for example, a speech message Mₛ of a user (the sender) can be recorded. This message record unit 25 can comprise, for example, a speech recognition system with which the speech message Mₛ is converted into text form. Furthermore, the robot comprises a motion control content generator 24, by means of which a motion control content is generated. This can be achieved by using the cameras 17 to record the movements of the user as he dictates the speech message Mₛ. The images can be analysed in a suitable image processing program (not shown in the diagram), and the movements can be converted by the motion control content generator 24 into motion control content. Both record content and motion control content are forwarded to a motion control content embedding unit 23 which then embeds the motion control content in the appropriate locations in the speech message.

At this point it should be noted that many of the components described above and below can, in turn, comprises several sub-components, or that several components can be realised as a single unit. For example, the motion control content generator 25 and the embedding unit 23 could be realised as a single component.

The completed message with embedded motion control content is then forwarded to a transmitter 22, which transmits the message M to the message rendering device 40. This can be effected in any suitable manner, for example by means of the usual type of communications network, mobile communications network, or first to a wireless LAN (WLAN) and then via the internet to a WLAN in the range of the receiver, and then on to the message rendering device. Whether the message is transmitted over cable or in a wireless manner is not relevant.

The message rendering device 40 is shown in the diagram also as a robot, but in a different form than the message transmitting device. Here, the message rendering device 40 has a round trunk 41, with legs 44 attached below, which in turn are equipped with feet 45. This robot also has arms 42 attached towards the top of the trunk 41, which in turn are equipped with hands 43. Again, the robot is only shown in a very simplified manner, and can in fact be equipped with any number of limbs.

The head 46 of the robot is realised as a hemisphere, attached directly to the trunk 41. The head can be rotated through 360°. Two cameras 47 are positioned on one side of the head, and serve as eyes. Two microphones are realised in the form of antennae 49 on top of the head. On one side, the hemispherical head 46 can be tipped upwards from a base 50 by a short distance, in order to simulate mouth movements. A loudspeaker 51 is incorporated here for speech output.

The message M sent by the message transmitting device 10 is first received by a receiver 56 and then forwarded to an analysing unit 57, in which the text of the message M is examined for motion control content, for example the form of certain tags. The remaining text is then passed on to a text-to-speech unit 60, which can convert the text back to speech.

The detected motion control content is passed on to an interpretation unit 58, which interprets the motion control content with the aid of a capability profile CP′ describing the capabilities of the message rendering device 40. This capability profile CP′ is stored in a memory 61, in which several capability profiles CP_{T}′ are stored for message transmitting devices with whom the message rendering device 40 frequently communicates.

Subsequently, the motion control content is converted in the interpretation unit 58 into a suitable form, so that the message rendering device 40 can carry out the commands specified in the motion control content. This motion control content is forwarded to a motion control unit 59, which controls the motion means such as drivers or motors for controlling various limbs or joints, and shown here simply as a block 62. The text to speech unit 60 outputs the text message Mₛ in speech form by means of the loudspeaker 51, synchronous to the movements.

To reply to a message, the message rendering device 40 also comprises a message recording unit 55, a motion control content generator 54, a motion control content embedding unit 53 and a transmitter 52. The message transmitting device 10 also comprises a receiver 26, a message analysing unit 27, a text to speech generator 30, an interpretation unit 28, a motion control unit 29 and corresponding motion means 32. Equally, this device 10 also comprises a memory 31 with its own capability profile CP and a number of capability profiles CP_{T} for other devices, stored for example in a database. When a message is received, the appropriate capability profile CP_{T} or CP_{T}′ can be retrieved from the memory on the basis of a sender ID in the header of the message.

FIG. 2 shows a short example of a message document comprising a message M, which could be sent by a similar type of message transmitting device as shown on the left-hand side of FIG. 1.

The message M consists of a message header MH and a message body MB. Evidently, the message header MH need not necessarily be placed at the head of the message M, but can be positioned at any location in the message M. It is only necessary that it be recognised as a message header MH by the recipient.

In this message header MH, a capability description of the message transmitting device is included, containing information pertaining to the setup and/or to a motion capabilities of the message rendering device in the form of tags H₁, H₂, H₃, H₄, H₅. The receiving device can then perform a conversion or translation of the following message body MB and the embedded tags T₁, T₂, T₃, T₄, T₅, pertaining to the motion content, based on the message header MH and using information about its own capabilities. The placement of the tags T₁, T₂, T₃, T₄, T₅, T₆, T₇ in the text automatically defines the points in the text or speech output at which the corresponding movements should be performed.

The first tag H₁ in the message header MH describes a head of size 20×20×15 cm. The second tag H₂ describes the jaw, and the third tag H₃ describes a trunk of the message transmitting device. The fourth tag H₄ describes that the lower jaw joint joins the head and lower jaw, whereby the head is fixed and the lower jaw is moveable in the Y direction between 0° and 30° relative to the head. The final tag H₅ describes the neck joint which attaches the trunk to the head (the robot does not actually have a neck as such, the neck is actually one piece with either the trunk or the head). The head can rotate 90° to the right or to the left, and can rotate between −40° upwards and 50° downwards.

Movements such as nodding or lower-jaw movements can thus be defined in the message body MB. When the robot acting as message rendering device also has such a lower-jaw controller, which, for example, can move the lower jaw during speech output, the actual implementation of the robot determines the extent to which the defined movements are actually performed.

The message body MB, i.e. the actual message, commences with a spoken sentence S₁ “Hi Peter”. At the same time, the robot looks downward, as specified by the first tag T₁.

The rest of the speech output follows: “I am truly sorry that my resent mail caused you grief. I apologize.” as given by the second sentence S₂. The tag T₂ immediately following specifies that the robot again looks up, for a duration of 0.5s. Then the next sentence S₃ follows “But let's forget it”.

The next tag T₃ is split in two parts T₃ₐ, T_{3b}, covering the next sentence S₄, a simple “Hey!”. These ensure that the robot looks up while “Hey!” is being spoken. The first part of the tag T₃ₐ defines the movement and the duration commencing from the start time of the tag T₃ₐ. The next part of the tag T_{3b} defines an end time for this movement within the message. In this example, the structure of the message ensures that the robot looks up for at least 0.5s, but only until the word “Hey!” has been spoken and the tag T_{3b} is executed, terminating the movement.

Another sentence S₅ follows: “I have an idea—let me invite you to a dinner this weekend.” The subsequent tags T₄, T₅, T₆ and T₇, whereby tags T₄ and T₆ are split into tags T₄ₐ, T_{4b}, T₆ₐ, T_{6b} to cover the sentences S₆, S₇, ensures that the robot laughs twice with clearly visible opening and closing of its mouth.

If the message rendering device which receives the message described above with the aid of FIG. 2 is a considerably simpler type of robot, for example with a moveable head but without any moveable lower jaw, all movements involving the jaw are ignored in the translation step. The description reveals the type of movement involved, so that, for example, the movements of the head are included in the rendered message. If the robot cannot deal with the specified start and end times or durations, these must also be ignored.

The entire operation can then be as follows:

Generation of the message M described in FIG. 2 can be performed in that the speech message Mₛ is entered by the user without any accompanying movements by means of a suitable user interface, and is output as speech. While the speech message Mₛ is being spoken, the user moves his robot or parts of the robot in the desired manner, in this case the jaw and head of the robot. The robot records these movements. A suitable message program containing the motion control content generator and the motion control content embedding unit records the movements, generates the corresponding motion control commands, and embeds these in the form of tags in the correct locations in the message text.

The message M is then sent as a message document comprising a message header MH and message body MB (see for example FIG. 2). At the receiver side, using the message header MH and the known capabilities of the message rendering device, a translation is performed in which certain translation rules are applied, based on the capabilities of the transmitting device and the capabilities of the rendering device. These translation rules can be stored with the capability profile, or in place of the capability profile, if a further communication is to take place between the two devices. Storing these translation rules is expedient especially when a message rendering device receives further messages, not only from the same sender, but from other senders with the same header, i.e. from message transmitting devices featuring the same capabilities.

According to the translation rules, a relationship is first established between the names of the body parts to be moved, specified in the header, and those of the message rendering device robot (e.g. the term “body” of the message transmitting device can be replaced by the term “trunk” since that is the term used by the message rendering device). Furthermore, for example, all elements with “joint=“jaw joint” can be deleted. In the example of FIG. 1, for the message described in FIG. 2, the lower jaw movements can be translated into upward tilting movements of the hemispherical head 46 from the base 50 of the message rendering device 40. Furthermore, all references to time can be deleted if the message rendering device is not capable of dealing with them.

The translation rules are then applied to the message document, and a “new”, translated message document is generated which can be rendered by the message rendering device.

The translation can be carried out, for example, in a separate device found in the path between the message transmitting device and the actual message rendering device, i.e. the robot.

In the manner portrayed above, a simple protocol for messages is described, carrying information about movements. Systems capable of carrying out such movements, such as, for example, user interface robots, can carry out these movements while presenting the accompanying message. In this way, the protocol supports, in a simple manner, synchronised movement with simultaneous message content presentation.

Although the present invention has been disclosed in the form of preferred embodiments and variations thereon, it will be understood that numerous additional modifications and variations could be made thereto without departing from the scope of the invention. For example, the message transmitting/rendering devices described are merely examples, which can be supplemented or modified by a person skilled in the art, without leaving the scope of the invention.

For the sake of clarity, it is to be understood that the use of “a” or “an” throughout this application does not exclude a plurality, and “comprising” does not exclude other steps or elements.

1. A method of sending a message (M) from a sender to a recipient
in which a record content (S₁, S₂, S₃, S₄, S₅, S₆, S₇) of the message (M) is recorded and supplemented with motion control content (T₁, T₂, T₃, T₄, T₅, T₆, T₇),
where the message (M) is transmitted from a transmitting device (10) of the sender to a message rendering device (40) of the recipient, which message rendering device (40) is capable of performing motion,
and where the message rendering device (40) is controlled according to the motion control content (T₁, T₂, T₃, T₄, T₅, T₆, T₇) to perform defined motion synchronised to a presentation of the record content (S₁, S₂, S₃, S₄, S₅, S₆, S₇) of the message (M).

2. A method according to claim 1, wherein the motion control content (T₁, T₂, T₃, T₄, T₅, T₆, T₇) is embedded in the record content (S₁, S₂, S₃, S₄, S₅, S₆, S₇) of the message (M) in the form of tags (T₁, T₂, T₃, T₄, T₅, T₆, T₇).

3. A method according to claim 1, where the message transmitting device (10) is also capable of performing motion and the motion control content (T₁, T₂, T₃, T₄, T₅, T₆, T₇) is described according to the setup and the motion capabilities of the message transmitting device (10) and where the motion control content (T₁, T₂, T₃, T₄, T₅, T₆, T₇) is translated into a description according to the setup and the motion capabilities of the message rendering device (40).

4. A method according to claim 3, where the translation of the motion control content (T₁, T₂, T₃, T₄, T₅, T₆, T₇) is done on a sender side based on information pertaining to a setup and/or to motion capabilities of the message rendering device (40).

5. A method according to claim 4, where the information pertaining to a setup and/or to motion capabilities of the message rendering device (40) is stored in a recipient profile memory (31) of the message transmitting device (10).

6. A method according to claim 3, where the translation of the motion control content (T₁, T₂, T₃, T₄, T₅, T₆, T₇) is done on a recipient side based on information pertaining to a setup and/or to motion capabilities of the message transmitting device (10).

7. A method according to claim 6, where the message (M) comprises information (H₁, H₂, H₃, H₄, H₅) pertaining to the setup and/or to motion capabilities of the message transmitting device (10).

8. A method according to claim 6, where the information pertaining to a setup and/or to motion capabilities of the message transmitting device (10) is stored in a sender profile memory (61) of the message rendering device (40).

9. A method according to claim 1, where the motion control content (T₁, T₂, T₃, T₄, T₅, T₆, T₇) includes a temporal starting point for a specific motion relative to the presentation of the message record content (S₁, S₂, S₃, S₄ S₅ S₆, S₇) and a temporal end point and/or a duration for the specific motion.

10. A method according to claim 1, where the motion control content (T₁, T₂, T₃, T₄, T₅, T₆, T₇) of a message (M) is generated based on a motion of the message transmitting device (10).

11. A message transmitting device (10) for transmitting a message (M) to a message rendering device (40) capable of performing motions, which message transmitting device (10) comprises
a message recorder (25) for recording a record content (S₁, S₂, S₃, S₄, S₅, S₆, S₇) of the message (M),
a motion control content generator (24) for generating motion control content (T₁, T₂, T₃, T₄, T₅, T₆, T₇),
a motion control content embedding unit (23) for embedding the motion control content (T₁, T₂, T₃, T₄, T₅, T₆, T₇) into the record content (S₁, S₂, S₃, S₄, S₅, S₆, S₇) of the message (M),
and a transmitter (22) for transmitting the message (M) to the message rendering device (40),
whereby the motion control content generator (24) and the motion control content embedding unit (23) are realized so that the motion control content (T₁, T₂, T₃, T₄, T₅, T₆, T₇) is generated and embedded in the record content (S₁, S₂, S₃, S₄, S₅, S₆, S₇) of the message (M) in such a way that the message rendering device (40) can be controlled, while presenting the message to the recipient, according to the motion control content (T₁, T₂, T₃, T₄, T₅, T₆, T₇) to perform defined motion synchronised to a presentation of the record content (S₁, S₂, S₃, S₄, S₅, S₆, S₇) of that message (M).

12. A message rendering device (40) comprising
a receiver (56) for receiving a message (M) from a message sending device (10),
outputting means (51) for presenting at least part of a record content of the message (M),
motion means (62) for performing motions of the body and/or parts of the body of the message rendering device (40),
a message analysing unit (57) for detecting motion control content (T₁, T₂, T₃, T₄, T₅, T₆, T₇) in the message (M),
a motion control unit (59) for controlling the motion means (62) according to the motion control content to perform defined motions synchronised to a presentation of the record content (S₁, S₂, S₃, S₄, S₅, S₆, S₇) of the message (M).

13. A message rendering device (40) according to claim 12 comprising
a message recorder (55) for recording a record content of the message (M),
a motion control content generator (54) for generating motion control content (T₁, T₂, T₃, T₄, T₅, T₆, T₇),
a motion control content embedding unit (53) for embedding the motion control content (T₁, T₂, T₃, T₄, T₅, T₆, T₇) into the record content (S₁, S₂, S₃, S₄, S₅, S₆, S₇) of the message (M),
and a transmitter (57) for transmitting the message (M) to another message rendering device,
whereby the motion control content generator (54) and the motion control content embedding unit (53) are realized so that the motion control content (T₁, T₂, T₃, T₄, T₅, T₆, T₇) is generated and embedded in the record content (S₁, S₂, S₃, S₄, S₅, S₆, S₇) of the message (M) in such a way that the other message rendering device can be controlled, while presenting the message (M) to the recipient, according to the motion control content (T₁, T₂, T₃, T₄, T₅, T₆, T₇) to perform defined motion synchronised to a presentation of the record content (S₁, S₂, S₃, S₄, S₅, S₆, S₇) of that message (M).

14. A message transmission system (1), comprising a message transmitting device (10) according to claim 11.
